(19) United States
(12) Patent Application Publication
(10) Pub. No.: US 2022/0240690 A1
(43) Pub. Date: Aug. 4, 2022

(54) DEVICE FOR TRAVELLING, WITH FASTENING AND TENSIONING ELEMENTS, WHICH FORMS A HORIZONTAL SURFACE ON A TRANSPORT SEAT

(71) Applicant: Cristina ESQUERRA MILCHORENA, Mexico City (MX)

(72) Inventor: Cristina ESQUERRA MILCHORENA, Mexico City (MX)

(21) Appl. No.: 17/617,860

(22) PCT Filed: Jul. 16, 2019
(86) PCT No.: PCT/IB2019/056083

§ 371 Date: Dec. 9, 2021

(51) Int. Cl. A47D 7/04; B60N 2/34

(52) U.S. Cl. CPC A47D 7/04; A47D 9/005; B60N 2/34

(57) ABSTRACT

A bed for use on an air, land or maritime transport seat has a main horizontal surface with two layers of fabric. An outer fabric layer, thinner than an inner layer, is supported by a reinforcement frame or edge. A system of fastening elements are provided by multiple short and long straps or belts that surround or attach to the transport seat. Tensioning elements for the fastening elements include a tensioner that allows a tension force to be exerted to maintain a horizontal position of the travel device which makes the device particularly suitable for babies and young children.

### CROSS REFERENCE TO RELATED APPLICATIONS

This application is a U.S. national stage of International Application No. PCT/IB2019/056083, filed on Jul. 16, 2019. The International Application is incorporated by reference herein in its entirety.

### BACKGROUND

Nowadays, travelling on air, land or maritime transport seats has become part of our lives. Every day it is possible to travel further thanks to the breakthroughs regarding transportation. People travel for long periods on seats similar to chairs which only allow them to sit with their back in an upright position. In particular, air travel requires sitting for long periods on a seat with limited space. The same applies to bus, train, or ship trips which now have similar seats.

One of the problems of these transport seats is that it is necessary to sit for long periods in a limited space which, firstly, is uncomfortable and, secondly, can result in lack of sleep, muscle pain and exhaustion, swollen limbs, and even more dangerous vascular affections, such as thrombosis and embolism.

In particular, children often need more hours of sleep and rest, so the problem is even more aggravated in them.

Numerous devices have been created to travel more comfortably. Examples are neck, back and feet supports; although these devices allow people to be more comfortable, they do not allow them to recline in a totally horizontal position and therefore, they do not completely solve the problem. Likewise, some of the seats in airplanes, buses, trains, and ships have a system that allows being reclined to adopt a more slightly horizontal position and/or extend a leg support; however, due to the limitations of space and reclining possibilities, the comfort level achieved is not ideal. Additionally, such seats do not allow to be reclined in a totally horizontal position and therefore, they do not completely solve the problem.

Thus, when travelling on some airplane, bus, train, or ship seats, it is desirable to have a completely horizontal surface, with enough support to allow adopting a horizontal reclined position, which allows for better rest and sleep and prevents afflictions related to sitting for long periods. The above is particularly desirable for young children.

Numerous devices, like the above mentioned, have been created to travel on transport seats in a horizontal position, examples of these are numerous systems of lower support (baggage items, cushions, pillows, and other inflatable elements); for example, those described in the patent application documents WO 2015/176097 A1, WO 2015/176130 A1 and WO 2019/010529 A1, which are placed in the space for the legs up to the necessary height, thereby achieving support for the lower part of the body allowing to adopt a horizontal position. However, as discussed above, these devices require using support elements (baggage items, cushions, pillows, and other inflatable elements) which are often very bulky and difficult to carry and transport, and/or require a lot of effort to put in place or install. Additionally, these devices may constitute a safety problem in case a transport evacuation is needed, since they require placing bulky and heavy support elements in passage spaces and therefore, due to their volume and weight, they constitute an obstruction risk for the evacuation. In addition, they are not ideal to be used by young children. Additionally, nowadays there are seats, particularly in airplanes, with reclining angles that enable to adopt a completely horizontal position; however, these systems involve technical issues related to the airplane space since it is necessary a bigger space among seats, thereby limiting the loading capacity of the airplane.

### SUMMARY

Described below is a new solution to the problem, both regarding the possibility to adopt a reclined position on transport seats and the creation of a device that does not require lower supports (baggage items, cushions, pillows, and other inflatable elements), is small, light, and easy to place on the seat, without requiring inflating cushions or pillows. Likewise, this device solves the safety and obstruction problems in case of evacuation that the above discussed devices have, since it has easy-release plastic fastenings it can be quickly and easily removed to allow free passage.

Specifically, described below is a device for travelling that forms a horizontal surface on an air, land or maritime transport seat using a flexible material that is attached to belts ending in fasteners, which can fasten to numerous elements of the seat itself, and which allow the device to develop enough tension to maintain the surface in an extended position. Thus, the device allows a person, particularly a child, to have a totally horizontal surface on an air, land or maritime transport seat using a flexible material attached to belts and fasteners, which can fasten to numerous elements of the seat itself, without requiring other additional elements, thereby being a device which is light, easy to transport and store, easy to install and uninstall; as well as completely safe.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a top view of the device for travelling with belts and fasteners.

FIG. 2 is a side view of the device for travelling with operating belts and fasteners.

FIG. 3 is a side perspective view of the rear portion of the device for travelling with operating belts and fasteners, where the rear belts and fasteners are shown. The arrows mark the direction in which the belts are rolled up.

FIG. 4 is a side perspective view of the front portion of the device for travelling with operating belts and fasteners, where the front belts and fasteners are shown. The arrows mark the direction in which the belts are rolled up.

FIG. 5 is a side perspective elevational view of the front portion of the device for travelling with operating belts and fasteners, where the front belts and fasteners are shown. The arrows mark the direction in which the belts are rolled up.

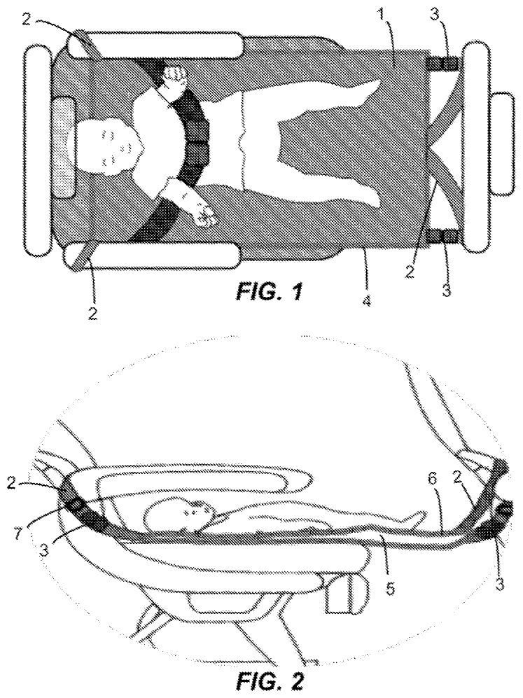

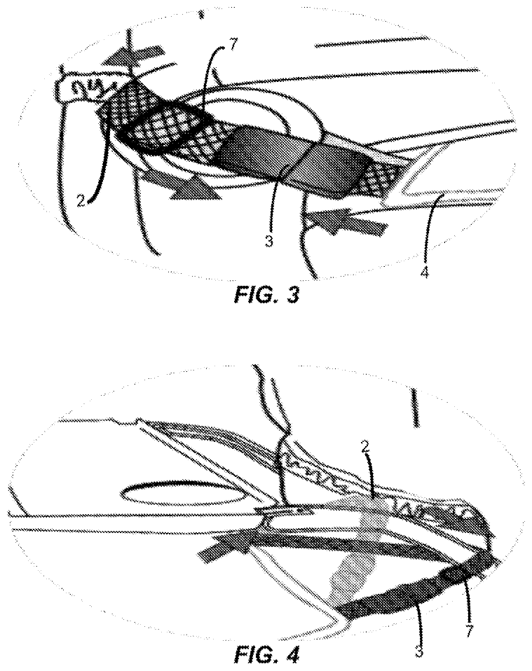

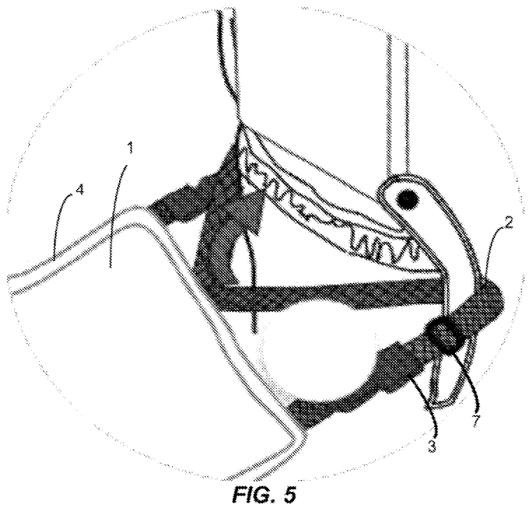

### DETAILED DESCRIPTION

Reference will now be made in detail to the preferred embodiments, examples of which are illustrated in the accompanying drawings, wherein like reference numerals refer to like elements throughout.

Described herein is a device for travelling that forms a horizontal surface on an air, land or maritime transport seat when it is placed and operating. In particular, due to the sizes of the device, it works either for 0-8-year-old children or for anyone whose size and dimensions enable them to use it.

The device has a main surface (1) of between 50-80 cm wide by between 50-100 cm long. Such surface may be composed of an outer layer (6), such as a 100% cotton fabric that is soft and hypoallergenic to avoid skin irritation in the users, or may be any natural hypoallergenic material. The outer layer (6) further includes a fabric frame or edge (4) of, e.g., 1-3 cm, which provides reinforcement for the whole device and may be composed of polyester or thick cotton fabrics, or combinations of natural and synthetic fabrics.

The main surface (1) has an inner layer (5) or filling that is thicker than the outer layer. In an embodiment, the inner layer (5) is composed of 100% wool felt which helps to concentrate the user's heat, thereby avoiding cooling in transport vehicles. Instead of wool, any natural hypoallergenic fabric may be used. In the outer layer (6), as well as in the inner layer (5), the fabric is divided into two portions to facilitate the folding and storage of the device.

The device further includes a series of fastening and tensioning elements that allow the device to be fastened to a transport seat and to be tensioned so that the tensioning force exerted by the fastening and tensioning elements allow maintaining the main surface in a horizontal position in its whole extension.

The fastening and tensioning elements may include a system of belts, fastenings, and tensioners. For example, about 6 to 12 straps or belts (2) in an embodiment are composed of nylon, which resists pressure and is light. Thus, it provides stability to the device, and because it is thin, it also facilitates storage. The belts (2) may also include belts composed of other natural, resistant, and light materials.

About 4 to 8 of these belts are placed at the ends of the device. About 2 to 6 of these belts, extending 1-8 cm out of the device and hereinafter called short belts, have fastening elements at their ends, which in an embodiment provide easy-attachment and release fastenings. For example, these fastenings may be made of plastic since it is a light material that facilitates storage and installation. About 2 to 4 of the belts, which are placed at the ends, extend 45-85 cm out of the device and are hereinafter called long belts. They are adjusted with a tensioner (7) in each one of these long belts, which in an embodiment may be a plastic tensioner. At the end of each of these long belts, there is a corresponding side of a buckle-type fastening to attach to the short belts. In an embodiment the corresponding side is made of plastic. About 2 to 4 belts extend between 50-85 cm out of the device from the central portion (fastened by the fabric frame or edge (4)), at each of their ends there is the matching side of the buckle-type fastening to attach them to the short belts placed at the ends.

The previous description must not be considered as limiting the invention, some of the considerations refer to particularly preferred embodiments and do not pretend to limit the scope derived from the described element. It will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-5. (canceled)

6. A device for travelling, which forms a horizontal surface on a transport seat, comprising:
flexible material having a main surface with preformed folds to reduce at least one dimension during transportation and storage of the device;
a system of elements that fasten the device to the transport seat, including 6 to 12 straps; 4 to 8 of end straps attached to ends of the device, including 2 to 4 short belts that have first fastenings and 2 to 4 long belts that have second fastenings coupling with the first fastenings of the short belts, and 2 to 4 central straps that extend out from a central portion of the device; and
tensioning elements.

7. The device according to claim 6, wherein the flexible material comprises:
a fabric frame that provides reinforcement, and
two layers of fabric, including an outer layer, and an inner layer thicker than the outer layer.

8. The device for travelling according to claim 7, wherein the tensioning elements comprise a tensioner in each of the long belts.

9. The device for travelling according to claim 6, wherein the tensioning elements comprise a tensioner in each of the long belts.
